(19) United States
(12) Patent Application Publication
(10) Pub. No.: US 2024/0035977 A1
(43) Pub. Date: Feb. 1, 2024

(54) MULTI-CHANNEL BIO-IMAGING DEVICES AND METHODS OF USING SAME

(71) Applicant: Azure Biosystems Inc., Dublin, CA (US)

(72) Inventors: Diping Che, San Ramon, CA (US); Wei Ding, Beijing (CN); Kun Li, Beijing (CN); Yuming Zhang, Guiyang (CN); Zhefu Zhang, Beijing (CN)

(21) Appl. No.: 18/360,803

(22) Filed: Jul. 28, 2023

Related U.S. Application Data
(60) Provisional application No. 63/393,009, filed on Jul. 28, 2022.

(51) Int. Cl. G01N 21/64

(52) U.S. Cl. CPC G01N 21/6456; G01N 2021/6419

(57) ABSTRACT

The present disclosure provides bio-imaging devices including multiple, modular channels for imaging biological substrates, and methods of using same to obtain mono- or multi-channel images of biological substrates.

### PRIORITY CLAIM

This application claims priority to U.S. Provisional Patent Application Ser. No. 63/393,009, filed on Jul. 28, 2022, the entire contents of which are incorporated herein and relied upon.

### FIELD

The present disclosure provides bio-imaging devices including multiple, modular (e.g., interchangeable) channels for imaging biological specimens, and methods of using same to obtain mono- or multi-channel images of biological specimens.

### BACKGROUND

Currently available multi-channel bio-imaging devices are known to suffer from “crosstalk” between adjacent channels, especially when the device scans two or more channels simultaneously. Without wishing to be bound by theory, it is presently believed that the crosstalk occurs when light (e.g., excitation light or emission light) from one channel is detected by the optical sensor of another channel, for example when the light scatters or diverges from its intended optical path due to interaction with mirrors, reflectors, glass surfaces, etc. One representation of this crosstalk is illustrated graphically in FIG. 1. Crosstalk creates undesirable imprecision in the observed (e.g., captured) light signals, and may appear in bio-images as ghosts, artifacts, blurred edges, and the like.

One method of reducing or eliminating crosstalk is to scan each channel separately. However, this method is undesirable because it substantially increases the time required to capture a multi-channel bio-image. In addition, changes in the specimen between iterative mono-channel scans may lead to inaccurate results for later-captured channels.

Further, known bio-imaging devices do not permit the user to conveniently change the excitation light source without substantially dismantling the device, or purchasing a new device to add a new excitation source to a research setting. The high cost to purchase a new bio-imaging device to utilize a new excitation source may be prohibitive.

A need therefore continues to exist for improved multi-channel bio-image devices, systems, and methods of analyzing biological substrates. Devices and systems consistent with the present disclosure meet this need.

### SUMMARY

The present disclosure provides bio-imaging devices including multiple, modular (e.g., interchangeable) channels for imaging biological specimens, and methods of using same to obtain mono- or multi-channel images of biological specimens.

In some embodiments, the present disclosure provides a bio-imaging device comprising: a first optical module; a second optical module; a scan bed configured to support a biological substrate and enable light radiation to pass therethrough; and a scan head disposed below the scan bed and in optical communication with the first optical module and the second optical module, the scan head comprising: a first scan lens in optical communication with the first optical module, a second scan lens in optical communication with the second optical module, a mirror in optical communication with each of the plurality of scan lenses, a first dye limiting filter (e.g., dual bandpass filter) disposed between the first scan lens and the mirror, and a second dye limiting filter (e.g., dual bandpass filter) disposed between the second scan lens and the mirror.

In some embodiments, the present disclosure provides an optical module comprising: a housing including: an aperture configured to permit light radiation to pass therethrough, a locking feature configured to mate with a complementary locking feature of a bio-imaging device, and at least one positioning feature configured to mate with a complementary positioning feature of a bio-imaging device; an illumination source disposed within the housing and configured to generate light radiation; a dichroic splitter disposed in optical communication with the aperture and the illumination source; a reflector disposed in optical communication with the dichroic splitter and the optical sensor; an optical sensor disposed in optical communication with the reflector; and optionally a lens disposed in optical communication with the reflector and the optical sensor.

In some embodiments, the present disclosure provides a bio-imaging device comprising: a scan bed including a surface configured to support a biological specimen; a scan head disposed below the scan bed and including at least one mirror disposed at an acute angle relative to the surface of the scan bed; a first receiver configured to: secure a first optical module as disclosed herein, and optically align the first optical module with a mirror of the scan head; a second receiver configured to: secure a second, different optical module as disclosed herein, and optically align the second, different optical module with a mirror of the scan head.

In some embodiments, the present disclosure provides a kit comprising: a first optical module as disclosed herein; a second, different optical module as disclosed herein; a third, different optical module as disclosed herein; and a bio-imaging device as disclosed herein.

In some embodiments, the present disclosure provides a method of obtaining a bio-image of a biological specimen, the method comprising: mating a first optical module as disclosed herein with a first receiver of a bio-imaging device as disclosed herein; optionally mating a second optical module as disclosed herein with a second receiver of a bio-imaging device as disclosed herein; optionally mating a third optical module as disclosed herein with a third receiver of a bio-imaging device as disclosed herein; placing a biological specimen on the scan bed of the bio-imaging device; and obtaining a single-channel or a multi-channel bio-image of the biological specimen via the first optical module, the optional second optical module, and/or the optional third optical module.

In some embodiments, the present disclosure provides a bio-imaging device comprising: a first optical module receiver configured to mate with a first removable optical module configured to emit and/or detect light for FRET, NIR, red, blue, or green fluorescent imaging; a second optical module receiver configured to mate with a second removable optical module configured to emit light for blue or red fluorescent imaging; a third optical module receiver configured to mate with a third removable optical module configured to emit and/or detect light for NIR or green fluorescent imaging; a scan bed configured to support a biological sample; and a scan head disposed to enable relay of light radiation from the first, second, and third removable optical modules with a biological sample supported by the scan bed, wherein the scan head comprises: a first dye limiting filter disposed between a first lens and a mirror and having at least two working wavelength ranges, and a second dye limiting filter disposed between a second lens and a mirror and having at least two working wavelength ranges that do not overlap with the working wavelength ranges of the first dye limiting filter.

### BRIEF DESCRIPTION OF THE DRAWINGS

FIG. 1 shows a multi-channel bio-imaging device consistent with the prior art.

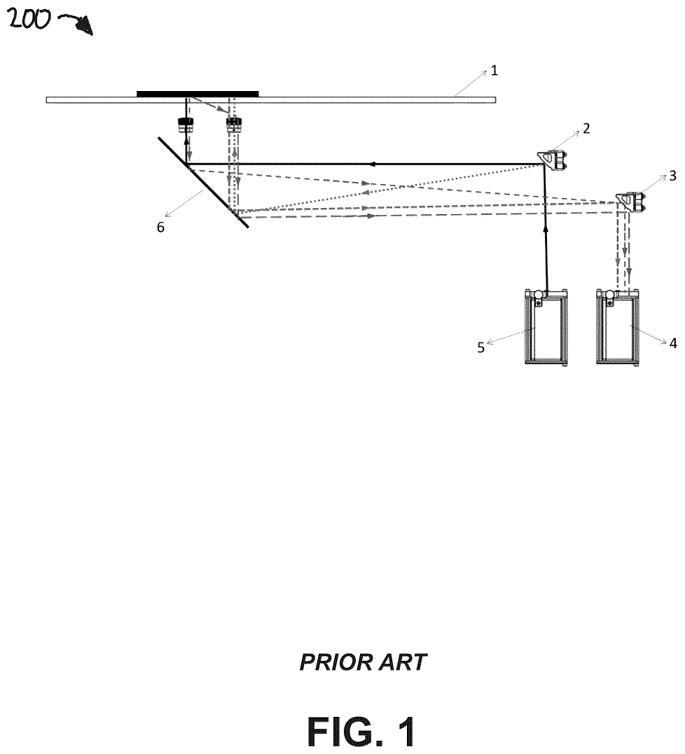

FIG. 2 shows a schematic view of optical paths of a modular multi-channel bio-imaging device consistent with one embodiment of the present disclosure.

FIG. 3 shows a perspective view of an optical module receiver of a bio-imaging device consistent with one embodiment of the present disclosure.

FIG. 4 shows a perspective view of an optical module consistent with one embodiment of the present disclosure.

FIG. 5 shows a schematic representative view of an optical path of the optical module of FIG. 4.

FIG. 6 shows a schematic representative view of an optical path of an optical module consistent with another embodiment of the present disclosure.

FIG. 7 shows working wavelengths of dual bandpass filters enabling simultaneous operation of three optical channels in a bio-imaging device consistent with one embodiment of the present disclosure.

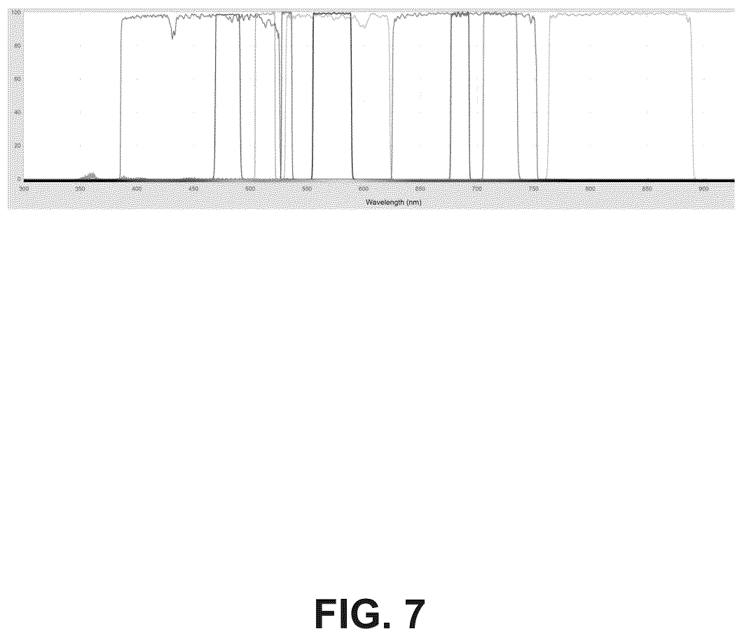

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

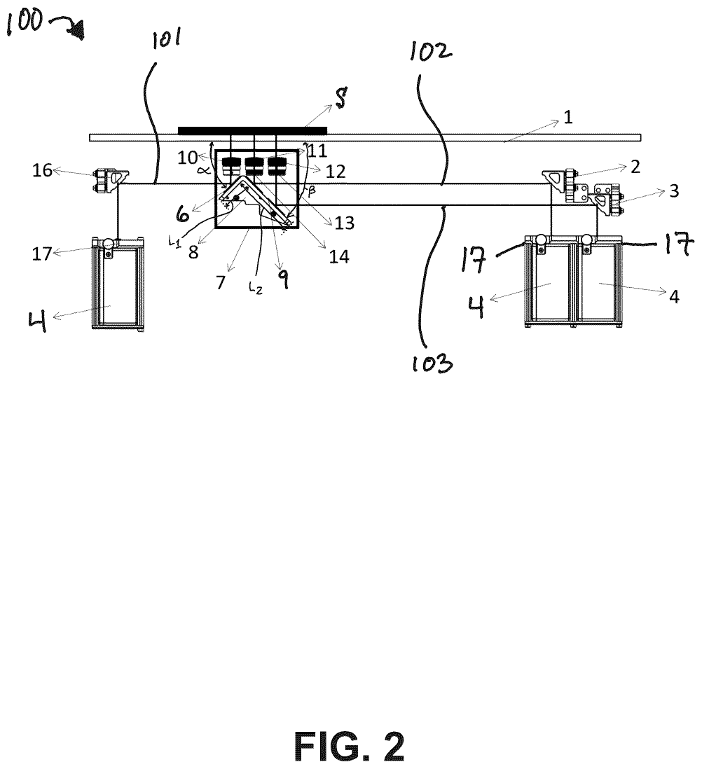

Referring generally to FIGS. 2-6, the present disclosure provides bio-imaging devices, optical modules configured for use in such bio-imaging devices, and methods of obtaining mono-channel or multi-channel bio-images of a specimen using a bio-imaging device as disclosed herein.

Bio-Imaging Devices

Bio-imaging devices 100 consistent with the present disclosure generally include a scan bed 1, a scan head 7, and one or more optical module receivers 17 configured to receive (e.g., temporarily secure) an optical module 4. Optionally, the bio-imaging device 100 further includes one or more reflectors 2/3/16 configured to redirect light radiation between the scan head 7 and one or more optical modules 4.

The scan bed 1 is configured to support a specimen S, such as an electrophoresis gel or blot. In some embodiments, the scan bed includes (e.g., consists essentially of or comprises) a plate glass, optionally including an antireflective coating on one or both surfaces to eliminate ghosts from the glass reflection.

The scan head 7 is disposed below the scan bed 1 (e.g., opposite the specimen S) and is configured to align light radiation between the specimen S or a portion thereof and the one or more optical modules 4. The scan head 7 may be configured to move, for example along one or more axes parallel or substantially parallel with the scan bed 1. In general, the scan head 7 includes at least one scan lens 10/11/12, and at least one mirror 6/9 in optical communication with each of the lenses 10/11/12. In some embodiments, the scan head 7 includes one lens 10/11/12 and one mirror 6/9 in optical communication with the lens 10/11/12.

In other embodiments, the scan head 7 includes two lenses 10/11/12, each in optical communication with a single mirror 6/9. In other embodiments, the scan head 7 includes a first lens 10 in optical communication with a first mirror 6, and a second lens 11/12 in optical communication with a second mirror 9.

In still other embodiments, the scan head 7 includes three lenses 10/11/12, each in optical communication with one or more mirrors 6/9. For example, the scan head 7 may include a first lens 10 in optical communication with one mirror 6, a second lens 11 in optical communication with a second mirror 9, and a third lens 12 in optical communication with the first mirror 6 or with the second mirror 9. In the embodiment specifically illustrated in FIG. 2, for example, the scan head 7 includes three lenses and two mirrors. A first lens 10 is in optical communication with the first mirror 6, while the second lens 11 and the third lens 12 are each in optical communication with the second mirror 9.

The at least one mirror 6/9 may include a first mirror 6 and a second, separate mirror 9 or, as shown representatively in the embodiment shown in FIG. 2, a single mirror with a first reflective surface 6 and a second reflective surface 9. When two mirrors 6/9 are present, the first mirror 6 may be disposed at a first angle α relative to the scan bed 1, and the second mirror 9 may be disposed at a second angle β to the scan bed 1. When a single mirror including two or more reflective surfaces is present, the first reflective surface 6 may be disposed at a first angle α relative to the scan bed 1, and the second reflective surface 9 may be disposed at a second angle β relative to the scan bed 1. In the embodiment shown representatively in FIG. 2, for example, the first reflective surface 6 of the mirror is disposed at a first angle α of about 45° relative to the scan bed 1, and the second reflective surface 9 is disposed at a second angle β of about 45° relative to the scan bed 1.

The length L₁ of the first mirror 6 or first reflective surface 6 may be greater than, about equal to, or less than the length L₂ of the second mirror 9 or the second reflective surface 9. In general, the mirrors 6/9 or reflective surfaces 6/9 having longer length Lx will enable reflection of more optical channels without crosstalk between channels.

The mirrors 6/9 or single mirror with multiple reflective surfaces 6/9 may be secured to the scan head 7 via a mirror carrier 8.

In some embodiments, a filter 13/14 (e.g., a dye-limiting filter or a dual bandpass filter) is disposed between the lens 10/11/12 and the mirror 6/9 or the reflective surfaces 6/9 of the mirror. In some embodiments, a first dual bandpass filter 13 having a first pair of working wavelength ranges is disposed between a third lens 12 and the mirror 6/9, and a second dual bandpass filter 14 having a second pair of working wavelength ranges is disposed between a second lens 11 and the mirror 6/9. In some such embodiments, the working wavelength ranges of the two dual bandpass filters do not overlap. For example and without limitation, the first dual bandpass filter 13 may have working wavelength ranges of 320-525 nm and 620-750 nm, while the second dual bandpass filter 14 may have working wavelength ranges of 530-620 nm and 760-900 nm.

In general, the working wavelength range(s) of the filter 13/14 corresponds to the wavelength of light emission from the optical module 4 in optical communication with the filter 13/14. For example and without limitation, when the first dual bandpass filter 13 has working wavelength ranges of 320-525 nm and 620-750 nm, the corresponding optical module may be configured to emit blue light (e.g., at about 488 nm) or to emit red light (e.g., at about 638 nm or at about 658 nm or at about 685 nm). As just one more example, when the second dual bandpass filter 14 has working wavelength ranges of 530-620 nm and 760-900 nm, the corresponding optical module 4 may be configured to emit green light (e.g., at about 532 nm) or to emit NIR light (e.g., at about 780 nm).

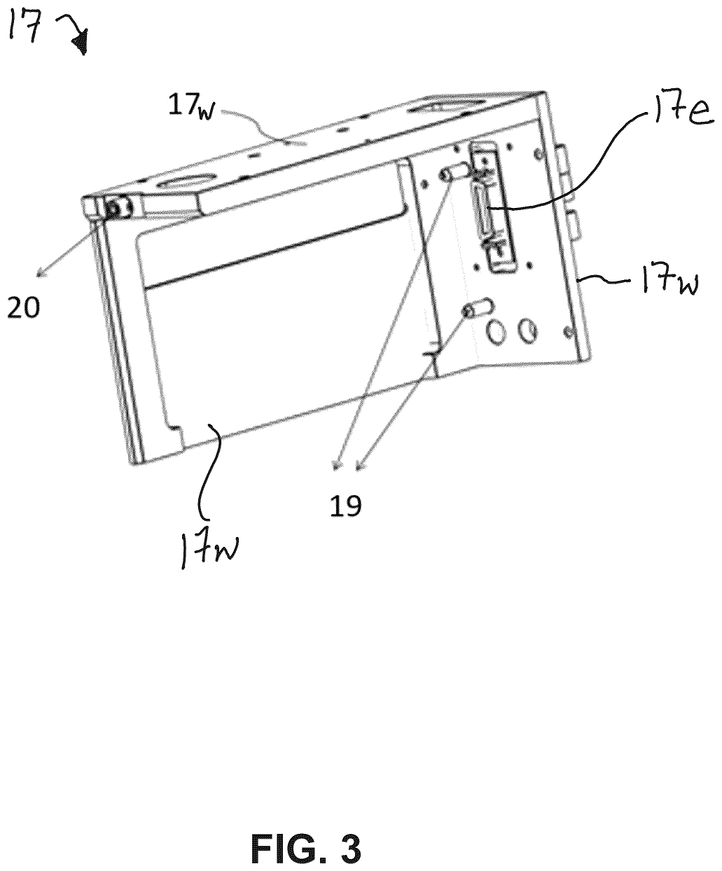

Disposing the filters 13/14 between the lens 11/12 and the mirror 6/9 results in reduced crosstalk between optical channels, especially when the working wavelengths of the filters 13/14 do not overlap. Referring now specifically to FIG. 3, bio-imaging devices 100 consistent with the present disclosure further include at least one optical module receiver 17 configured to secure (e.g., temporarily secure) an optical module and align the optical components of the secured optical module with the scan head 7.

The optical module receiver 17 may include one or more side walls 17w configured to abut one or more walls of an optical module 4. The optical module receiver 17w may include at least one positioning pin 19, for example disposed on an inner surface of one of the side walls 17w, to mate with (e.g., temporarily mate with) one or more positioning holes 21 of an optical module 4. The positioning pin(s) 19 may be arranged on one or more side walls 17w and/or on an inner surface of the bio-imaging device 100 to enable alignment of the optical components of the optical module 4 with the optical components of the scan head 7. For example and without limitation, the positioning pins 19 may be arranged in the optical module receiver 17 in an asymmetric pattern to prevent installation of an optical module 4 in an improper orientation.

In some embodiments, the optical module receiver 17 includes a locking feature 20, such as a locking screw nut. The locking feature 20 is configured to mate (e.g., temporarily mate) with a locking feature (e.g., a locking screw) of an optical module 4 to further secure the optical module 4 in the optical module receiver 17.

In some embodiments, the positioning pin(s) 19 are arranged in the optical module receiver 17 to enable only some optical modules 4 to be installed in specific optical module receivers 17 of a bio-imaging device 100. For example and without limitation, arrangement of positioning pins 19 in an optical module receiver 17 may enable installation of a blue light-emitting optical module 4 only in a position that aligns blue light radiation emitted from the optical module 4 with a compatible filter 13/14 disposed in the corresponding optical path 11/102/103, but prevents installation of an optical module 4 that emits radiation incompatible with the filter 13/14 of that optical path 101/102/103.

Optical module receivers 17 consistent with the present disclosure enable convenient alignment of the optical components of an optical module 4 with the optical components of the scan head 7. In some embodiments, the optical module receiver 17 enables alignment of the optical components of the optical module 4 with the optical components of the scan head 7 without the need to run alignment procedures. In some embodiments, the optical module receiver 17 enables alignment of the optical components of the optical module 4 with the optical components of the scan head 7 within 0.1 mm without further alignment. In some embodiments, the optical module receiver 17 enables alignment of the optical components of the optical module 4 with the optical components of the scan head 7 within 0.09 mm without further alignment. In some embodiments, the optical module receiver 17 enables alignment of the optical components of the optical module 4 with the optical components of the scan head 7 within 0.08 mm without further alignment. In some embodiments, the optical module receiver 17 enables alignment of the optical components of the optical module 4 with the optical components of the scan head 7 within 0.07 mm without further alignment. In some embodiments, the optical module receiver 17 enables alignment of the optical components of the optical module 4 with the optical components of the scan head 7 within 0.06 mm without further alignment. In some embodiments, the optical module receiver 17 enables alignment of the optical components of the optical module 4 with the optical components of the scan head 7 within 0.05 mm without further alignment. In some embodiments, the optical module receiver 17 enables alignment of the optical components of the optical module 4 with the optical components of the scan head 7 within 0.04 mm without further alignment. In some embodiments, the optical module receiver 17 enables alignment of the optical components of the optical module 4 with the optical components of the scan head 7 within 0.03 mm without further alignment. In some embodiments, the optical module receiver 17 enables alignment of the optical components of the optical module 4 with the optical components of the scan head 7 within 0.02 mm without further alignment. In some embodiments, the optical module receiver 17 enables alignment of the optical components of the optical module 4 with the optical components of the scan head 7 within 0.01 mm without further alignment.

The optical module receiver 17 also, in some embodiments, includes an electrical connector 17e configured to engage with the electrical connector 4e of an optical module 4. The electrical connector 17e, when present, is configured to engage with a cable or other data transmission feature (e.g., WiFi or Bluetooth protocol transceiver) to receive and transmit data from and to an engaged optical module 4 and/or with a power supply of the bio-imaging device 100 to provide power to the optical module 4.

In some embodiments, the bio-imaging device 100 further includes one or more reflectors 2/3/16 in optical communication between an optical module 4 and the scan head 7. The reflectors 2/3/16 may be disposed at an angle sufficient to reflect light radiation between the mirror 6/9 and the corresponding optical module 4.

In some embodiments, the present disclosure provides a bio-imaging device 100 comprising: a first optical module 4; a second optical module 4; a scan bed 1 configured to support a biological substrate S and enable light radiation to pass therethrough; and a scan head 7 disposed below the scan bed 1 and in optical communication with the first optical module 4 and the second optical module 4, the scan head 7 comprising: a first scan lens 10/11/12 in optical communication with the first optical module 4, a second scan lens 10/11/12 in optical communication with the second optical module 4, a mirror 6/9 in optical communication with each of the plurality of scan lenses 10/11/12, a first dye limiting filter 13/14 (e.g., dual bandpass filter) disposed between the first scan lens 10/11/12 and the mirror 6/9, and a second dye limiting filter 13/14 (e.g., dual bandpass filter) disposed between the second scan lens 10/11/12 and the mirror 6/9. In some embodiments, the bio-imaging device 100 comprises: a first optical module receiver 17; a first optical module 4 configured to reversibly mate with the first optical receiver 17; a second optical module receiver 17; and a second optical module 4 configured to reversibly mate with the second optical receiver 17. In some embodiments, the first optical module 4 comprises: a housing 4h including: an aperture 5 configured to permit light radiation to pass therethrough, a locking feature 22 configured to mate with a complementary locking feature 20 of the bio-imaging device, and at least one positioning feature 21 configured to mate with a complementary positioning feature 19 of the bio-imaging device 100; an illumination source 23 disposed within the housing 4h and configured to generate light radiation; a dichroic splitter 25 disposed in optical communication with the aperture 5 and the illumination source 23; a reflector 26 disposed in optical communication with the dichroic splitter 25 and the optical sensor 30/31; an optical sensor 30/31 disposed in optical communication with the reflector 26; and optionally a lens 27 disposed in optical communication with the reflector 25 and the optical sensor 30/31; and the second optical module 4 comprises: a second housing 4h including: a second aperture 5 configured to permit light radiation to pass therethrough, a second locking feature 22 configured to mate with a second complementary locking feature 20 of the bio-imaging device 100, and at least one second positioning feature 21 configured to mate with a complementary second positioning feature 19 of the bio-imaging device 100; a second illumination source 23 disposed within the second housing 4h and configured to generate light radiation; a second dichroic splitter 25 disposed in optical communication with the second aperture 5 and the second illumination source 23; a second reflector 26 disposed in optical communication with the second dichroic splitter 25 and the second optical sensor 30/31; a second optical sensor 30/31 disposed in optical communication with the second reflector 26; and optionally a second lens 27 disposed in optical communication with the second reflector 26 and the second optical sensor 30/31; a scan bed 1 configured to support a biological substrate S and enable light radiation to pass therethrough; and a scan head 7 disposed below the scan bed 1 and including: a plurality of scan lenses 10/11/12, and a mirror 6/9 in optical communication with each of the plurality of scan lenses 10/11/12. In some embodiments, the bio-imaging device 100 further comprises: a third optical module receiver 17; and a third optical module 4 configured to reversibly mate with the third optical receiver 17. In some embodiments, the third optical module 4 comprises: a third housing 4h including: a third aperture 5 configured to permit light radiation to pass therethrough, a third locking feature 22 configured to mate with a third complementary locking feature 20 of the bio-imaging device 100, and at least one third positioning feature 21 configured to mate with a complementary third positioning feature 19 of the bio-imaging device 100; a third illumination source 23 disposed within the third housing 4h and configured to generate light radiation; a third dichroic splitter 25 disposed in optical communication with the third aperture 5 and the third illumination source 23; a third reflector 26 disposed in optical communication with the third dichroic splitter 25 and the third optical sensor 30/31; a third optical sensor 30/31 disposed in optical communication with the third reflector 26; and optionally a third lens 27 disposed in optical communication with the second reflector 26 and the second optical sensor 30/31. In some embodiments, the mirror 6/9 includes at least two reflective faces 6, 9. In some embodiments, a first face 6 of the mirror is configured to place a first scan lens 10 in optical communication with the first optical module 4. In some embodiments, a second face 9 of the mirror is configured to place a second scan lens 11 in optical communication with the second optical module 4. In some embodiments, the first face 6 of the mirror or the second face 9 of the mirror is configured to place a third scan lens 12 in optical communication with the third optical module 4. In some embodiments, the scan head 7 is configured to move relative to the scan bed 1. In some embodiments, the scan head 7 is in optical communication with the third optical module 4 and further comprises a third scan lens 10/11/12 in optical communication with the third optical module 4. In some embodiments, the scan head 7 does not include a dye limiting filter 13/14 disposed between the third scan lens 10/11/12 and the mirror 6/9. In some embodiments, the first dye limiting filter 13/14 is a dual bandpass filter. In some embodiments, the dual bandpass filter has a first working wavelength range of 320-525 nm and a second working wavelength range of 620-750 nm. In some embodiments, the second dye limiting filter is a dual bandpass filter. In some embodiments, the second dual bandpass filter has a working wavelength range that does not overlap with a working wavelength range of the first dye limiting filter. In some embodiments, the second dual bandpass filter has a first working wavelength range of 530-620 nm and a second working wavelength range of 760-900 nm.

In some embodiments, the present disclosure provides a bio-imaging device 100 comprising: a first optical module receiver 17 configured to mate with a first removable optical module 4 configured to emit and/or detect light for FRET, NIR, red, blue, or green fluorescent imaging; a second optical module receiver 17 configured to mate with a second removable optical module 4 configured to emit and/or detect light for blue or red fluorescent imaging; a third optical module receiver 17 configured to mate with a third removable optical module 4 configured to emit and/or detect light for NIR or green fluorescent imaging; a scan bed 1 configured to support a biological sample S; and a scan head 7 disposed to enable relay of light radiation from the first, second, and third removable optical modules 4 with a biological sample S supported by the scan bed 1, wherein the scan head 7 comprises: a first dye limiting filter 13/14 disposed between a first lens 10/11/12 and a mirror 6/9 and having at least two working wavelength ranges, and a second dye limiting filter 13/14 disposed between a second lens 10/11/12 and a mirror 6/9 and having at least two working wavelength ranges that do not overlap with the working wavelength ranges of the first dye limiting filter 13/14. In some embodiments, the scan head 7 comprises: a first reflective surface 6 configured to redirect light emitted by the first removable optical module 4 to the biological sample S; and a second reflective surface 9 configured to redirect light emitted by the second removable optical module 4 and the third removable optical module 4 to the biological sample S. In some embodiments, the scan 7 head comprises: a first lens 10 disposed between the first reflective surface 6 and the scan bed 1 and configured to focus light emitted by the first removable optical module 4 to the scan bed 1; a second lens 11 disposed between the second reflective surface 9 and the scan bed 1 and configured to focus light emitted by the second removable optical module 4 to the scan bed 1; and a third lens 12 disposed between the second reflective surface 9 and the scan bed 1 and configured to focus light emitted by the third removable optical module 4 to the scan bed 1. In some embodiments, the bio-imaging device 100 further comprises: a first filter 13 disposed between the first reflective surface 6 and the first lens 10 and configured to enable passage of FRET, NIR, red, green, and blue light; a second filter 13 disposed between the second reflective surface 9 and the second lens 11 and configured to enable passage of blue and red light; and a third filter 14 disposed between the second reflective surface 9 and the third lens 12 and configured to enable passage of NIR and green light. In some embodiments, a working wavelength range of the second filter 13 does not overlap with a working wavelength range of the third filter 14. In some embodiments, the first filter 13 between the first lens 10 and the mirror 6 is not present. In some embodiments, the second filter 13 is a 320-525 nm/620-750 nm dual bandpass filter. In some embodiments, the third filter 14 is a 530-620 nm/760-900 nm dual bandpass filter. In some embodiments, the second optical module receiver 17 is configured to not mate with an optical module 4 configured to emit fluorescent, NIR, or green light. In some embodiments, the third optical module receiver 17 is configured not to mate with an optical module 4 configured to emit FRET, red, or blue light.

Optical Modules

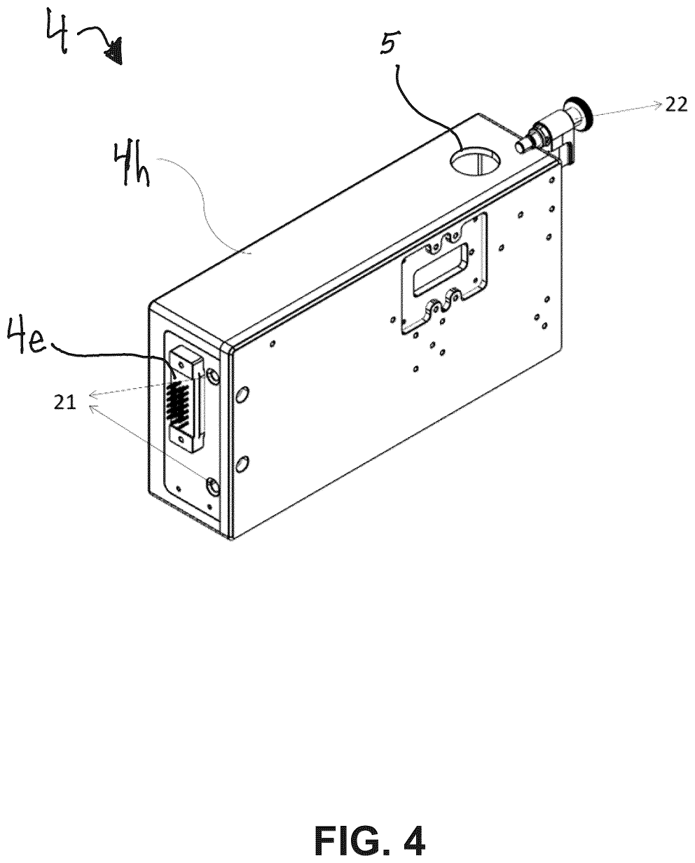

Referring now to FIGS. 4-6, the present disclosure provides optical modules 4 configured to mate (e.g., temporarily mate) with an optical module receiver 17 of a bio-imaging device 100. Optical modules 4 generally include a housing 4h, a light emitter 23, a sensor 30/31, and various optical components 24-29.

The housing 4h may include a aperture 5 through which light radiation may enter and/or exit the housing 4h. In some embodiments, the aperture 5 is an aperture in the housing 4h.

The housing 4h also generally includes positioning features 21 configured to mate (e.g., temporarily mate) with positioning pins 19 of a corresponding optical module receiver 17. In some embodiments, the positioning features 21 are disposed to enable an optical module 17 to mate only with fewer than all optical module receivers 17 of a bio-imaging device 100. For example and without limitation, the positioning features 21 of an optical module 17 including a light emitter 23 that emits a near infrared (NIR) light may enable installation of the optical module 17 in an optical module receiver 17 of a bio-imaging device 100 aligned with a filter 13/14 that allows passage of NIR light but not with an optical module receiver 17 of the bio-imaging device 100 aligned with a filter 13/14 that does not enable passage of NIR light.

In some embodiments, the housing 4h includes an electrical connector 4e configured to mate with the electrical connector 17e of a corresponding optical module receiver 17. The electrical connector 4e may be configured, for example, to enable transmission of data and/or power to and/or from the bio-imaging device 100.

The housing 4h may also include a locking feature 22, such as a screw, configured to mate (e.g., temporarily mate) with the locking feature 20 of the optical module receiver 17. When engaged with the locking feature 20 of the optical module receiver, the locking feature 22 of the housing 4h may align (e.g., substantially align) the optical path 101/102/103 of the optical module 4 with the scan head 7, for example within 0.1 mm, within 0.09 mm, within 0.08 mm, within 0.07 mm, within 0.06 mm, within 0.05 mm, within 0.04 mm, within 0.03 mm, within 0.02 mm, or within 0.01 mm.

The housing 4h may support optical components including, for example, a light source 23. The light source 23 may emit light suitable for FRET, NIR, red, blue, or green fluorescent imaging. The light source 23 may be a laser.

The emitted light may optionally pass through an excitation filter 24 with optical properties corresponding to the wavelength of emitted light.

The emitted light may strike a dichroic splitter 25 configured to reflect the emitted light through the aperture 5. The light reflected through the aperture 5 may then be redirected by the mirror 6/9 or one of the reflective surfaces 6/9 of the mirror, optionally after being redirected by a reflector 2/3/16, if present.

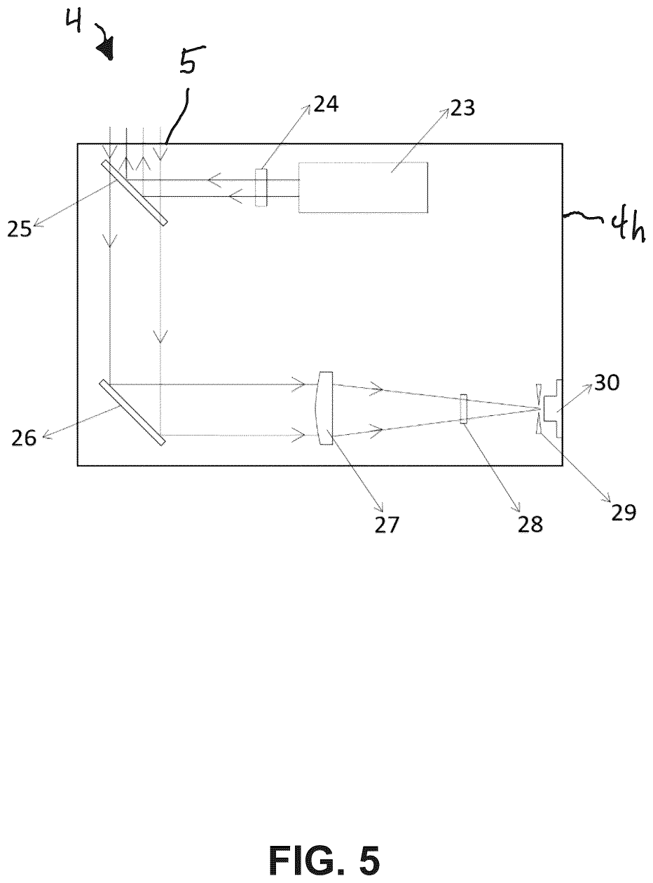

In some embodiments, such as those generally consistent with the embodiment shown representatively in FIG. 5, the sensor 30 is disposed within the housing 4h. In such embodiments, the sensor 30 may be an avalanche photodiode (APD).

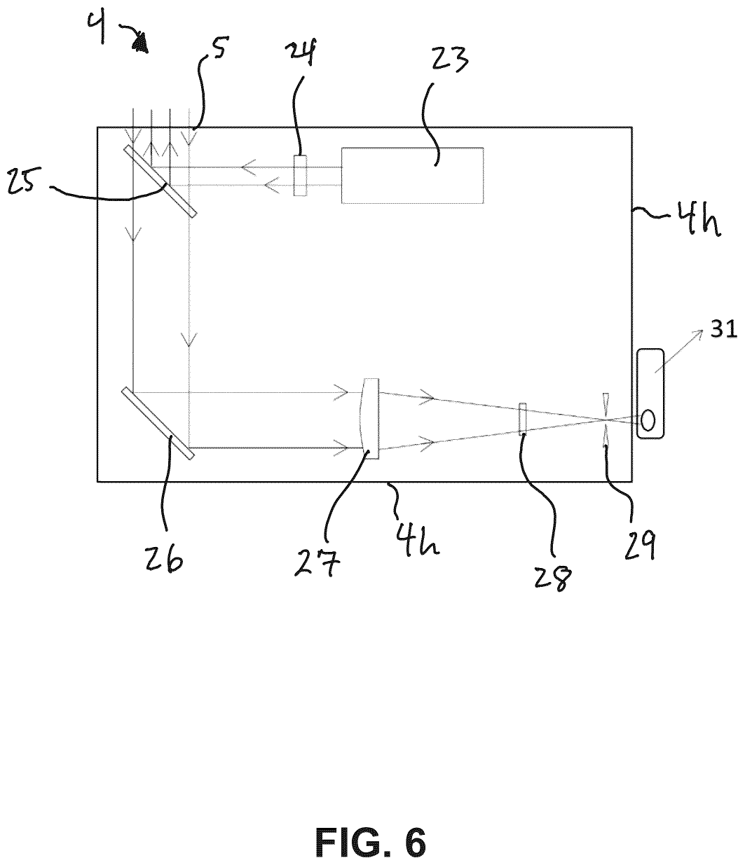

In other embodiments, such as those generally consistent with the embodiment shown representatively in FIG. 6, the sensor 31 is disposed an exterior of the housing 4h. In such embodiments, the sensor 31 may be a photomultiplier tube type photoelectrical sensor (PMT).

The aperture 5 is configured to enable light emitted by or transmitted by the biological sample S on the scan bed 1 via the scan head 7 and optional reflector 2/3/16 to reenter the housing 4h. Upon reentry, the light passes through the dichroic splitter 25 to the sensor 30/31, via the optional internal reflector 26, the lens 27, the emission filter 28, and aperture 29.

In some embodiments, the present disclosure provides an optical module 4 comprising: a housing 4h including: an aperture 5 configured to permit light radiation to pass therethrough, a locking feature 22 configured to mate with a complementary locking feature 20 of a bio-imaging device 100, and at least one positioning feature 21 configured to mate with a complementary positioning feature 19 of a bio-imaging device 100; an illumination source 23 disposed within the housing 4h and configured to generate light radiation; a dichroic splitter 25 disposed in optical communication with the aperture 5 and the illumination source 23; a reflector 26 disposed in optical communication with the dichroic splitter 25 and the optical sensor 30/31; an optical sensor 30/31 disposed in optical communication with the reflector 26; and optionally a lens 27 disposed in optical communication with the reflector 26 and the optical sensor 30/31. In some embodiments, the optical module 4 further comprises an excitation filter 24 in optical communication with the illumination source 23 and the dichroic splitter 25. In some embodiments, the optical module 4 further comprises an emission filter 28 disposed in optical communication with the lens 27 and the optical sensor 30/31. In some embodiments, the optical module 4 further comprises a second aperture 29 disposed between the lens 27 and the optical sensor 30/31. In some embodiments, the optical sensor 30 is disposed within the housing. In some embodiments, the optical sensor 31 is disposed on an exterior surface of the housing 4h. In some embodiments, the illumination source 23 emits light radiation having a wavelength of 488 nm, 532 nm, 638 nm, 658 nm, 685 nm, or 780 nm. In some embodiments, the optical module 4 is configured to illuminate a specimen and/or receive light from a specimen for phosphor imaging, FRET imaging, NIR imaging, red fluorescent imaging, green fluorescent imaging, or blue fluorescent imaging. In some embodiments, the at least one positioning feature 21 is disposed to prevent the optical module 4 from being inserted into one or more optical module receivers 17 of a multi-receiver bio-imaging device 100. In some embodiments, the locking feature 21 is configured to mate with the complementary positioning feature 19 of a bio-imaging device 100 to align the optical sensor with a scan head of the bio-imaging device within 0.1 mm, within 0.08 mm, within 0.06 mm, within 0.04 mm, within 0.03 mm, within 0.02 mm, or within 0.01 mm.

Methods of Use

The present disclosure provides methods of obtaining a bio-image of a sample S, such as a multi-channel bio-image of the sample S. In some embodiments, the method results in capture of a multichannel bio-image with reduced (e.g., substantially reduced) crosstalk (e.g., interference) between the various channels.

Generally, a method of the present disclosure comprises installing one or more optical modules 4 corresponding to the desired illumination channel(s) in a bio-imaging device 100 including one or more optical module receivers 17; placing a biological sample S on a scan bed 1 of the bio-imaging device 100; illuminating the biological sample S with light emitted by the one or more installed optical module(s) 4; and collecting data captured by sensors 30/31 of the optical module(s) 4.

In operation, the filters 13/14 reduce or even eliminate (e.g., substantially eliminate) crosstalk between optical channels. Generally, the term “crosstalk” refers to signal observed by an optical sensor 30/31 of one channel of an imaging instrument that originates from a second, different channel of the imaging instrument. Reduction or elimination of crosstalk in multichannel imaging devices has been a persistent problem in the art.

In one embodiment, optical channel 101 includes an optical module 4 configured to emit blue light (e.g., having an excitation wavelength of about 488 nm). The working wavelength of the excitation beam filter 24 of the optical module 4 is about 488 nm, and the working wavelength of the fluorescence filter 28 of the optical module 4 is about 513 nm. Optical channel 102 includes a second optical module 4 configured to emit red light (e.g., having an excitation wavelength of about 685 nm). The working wavelength of the excitation beam filter 24 of the second optical module 4 is about 685 nm, and the working wavelength of the fluorescence filter 28 of the optical module 4 is about 720 nm. Optical channel 103 includes a third optical module 4 configured to emit green light (e.g., having an excitation wavelength of about 532 nm). The working wavelength of the excitation beam filter 24 of the third optical module 4 is about 532 nm, and the working wavelength of the fluorescence filter 28 of the third optical module 4 is about 572 nm.

In operation, the blue excitation light emitted by the first optical module 4 (e.g., optical channel 101) at about 488 nm passes through the excitation filter 24, and then is deflected out of the aperture 5 of the optical module 4 by the dichroic splitter 25. The excitation beam then impinges upon the reflector 16 and enters the scan head 7. In the scan head 7, the excitation beam is deflected by the scan mirror 6 and then passes through the scan lens 10, through the scan bed 1 and to the sample S. The fluorescence emission from the sample S is directed along a path substantially retracing the path 101 of the excitation beam through the scan lens 10, then to the mirror 6 and reflector 16 and back into the optical module 4 via the aperture 5. Once in the optical module 4, the fluorescence emission passes through the dichroic splitter 25, is reflected by a fluorescence reflector 26, then passes through the lens 27, the fluorescence filter 28, the aperture 29 and is finally detected by a photoelectric sensor 30/31.

Simultaneously or nearly simultaneously, red light emitted by the second optical module 4 (e.g., optical channel 102) at about 685 nm passes through the excitation filter 24, and then is deflected out of the aperture 5 of the second optical module 4 by the dichroic splitter 25. The red excitation beam then impinges upon the reflector 2 and enters the scan head 7. In the scan head 7, the excitation beam is deflected by the scan mirror 9 and then passes through the dual bandpass filter 14, through the scan lens 11, and through the scan bed 1 to the sample S. The fluorescence excited by the beam passes from the sample S through the scan lens 11 and the dual bandpass filter 14 before being reflected by the scan mirror 9 and the reflector 2 to the second optical module 4 via the aperture 5. Once in the second optical module 4, the fluorescence emission passes through the dichroic splitter 25, is reflected by a fluorescence reflector 26, then passes through the lens 27, the fluorescence filter 28, the aperture 29 and is finally detected by a photoelectric sensor 30/31.

Simultaneously or nearly simultaneously, green light emitted by the third optical module 4 (e.g., optical channel 103) at about 532 nm passes through the excitation filter 24, and then is deflected out of the aperture 5 of the third optical module 4 by the dichroic splitter 25. The green excitation beam then impinges upon the reflector 3 and enters the scan head 7. In the scan head 7, the excitation beam is deflected by the scan mirror 9 and then passes through the dual bandpass filter 13, through the scan lens 12, and through the scan bed 1 to the sample S. The fluorescence excited by the beam passes from the sample S through the scan lens 12 and the dual bandpass filter 13 before being reflected by the scan mirror 9 and the reflector 3 to the third optical module 4 via the aperture 5. Once in the third optical module 4, the fluorescence emission passes through the dichroic splitter 25, is reflected by a fluorescence reflector 26, then passes through the lens 27, the fluorescence filter 28, the aperture 29 and is finally detected by a photoelectric sensor 30/31.

Due at least in part to scattering from reflector 2, part of the excitation light from optical channel 102 is undesirably scattered and might enter the scan lens 12 in optical channel 103. However, the working wavelength of the dual bandpass filter 13 in channel 103 blocks all or substantially all of the scattered excitation beam from adjacent optical channel 102 from entering the scan lens 12 of optical channel 103, thus reducing or even eliminating crosstalk. Similarly, scattering from reflector 3 of optical channel 103 may ordinarily undesirably enter lens 11 of optical channel 102. However, the working wavelength of the dual bandpass filter 14 in optical channel 102 blocks all or substantially all of the scattered excitation beam from adjacent optical channel 103 from entering the scan lens 11 of optical channel 102, thus reducing or even eliminating crosstalk.

Crosstalk also may ordinarily result from scattering of excitation and/or emission light from the scan bed 1. However, disposing the dual bandpass filters 13, 14 between the lens 11, 12 and the mirror 6/9 reduces or eliminates undesirable crosstalk from light scattered by the scan bed 1.

The step of installing the optical module(s) 4 into the bio-imaging device 100 may include mating one or more positioning features 21 of the optical module 4 with positioning features 19 of the optical module receivers 17 of the bio-imaging device 100. The step of installing the optical module(s) 4 may also or alternatively include securing a locking feature 22 of the optical module 4 to a locking feature 20 of the optical module receiver 17.

In some embodiments, the step of installing the optical module 4 is sufficient to align (e.g., substantially align) the optical path 101/102/103 created by the optical module 4 with the scan head 7 of the bio-imaging device 100. In some embodiments, installing the optical module 4 in the optical module receiver 17 by mating the complementary positioning features 19, 21 and/or securing the complementary locking features 20, 22 aligns the optical path 101/102/103 created by the optical module 4 with the scan head 7 within 0.1 mm, within 0.09 mm, within 0.08 mm, within 0.07 mm, within mm, within 0.05 mm, within 0.04 mm, within 0.03 mm, within 0.02 mm, or within 0.01 mm.

In some embodiments, the method does not include a step of adjusting an alignment of the optical path 101/102/103 created by the optical module 4 with the scan head 7 after the step of mating the complementary positioning features 19, 21 and/or securing the complementary locking features 20, 22 is complete. In some embodiments, the method does not include a step of adjusting an alignment of the optical path 101/102/103 created by the optical module 4 with the scan head 7 before the step of mating the complementary positioning features 19, 21 and/or securing the complementary locking features 20, 22 has commenced.

### EXAMPLES

Example 1. A bio-imaging device comprising:
   a first optical module;
   a second optical module;
   a scan bed configured to support a biological substrate and enable light radiation to pass therethrough; and
   a scan head disposed below the scan bed and in optical communication with the first optical module and the second optical module, the scan head comprising:
      a first scan lens in optical communication with the first optical module,
      a second scan lens in optical communication with the second optical module,
      a mirror in optical communication with each of the plurality of scan lenses,
      a first dye limiting filter disposed between the first scan lens and the mirror, and
      a second dye limiting filter disposed between the second scan lens and the mirror.
Example 2. The bio-imaging device of Example 1, wherein:
   the first optical module comprises:
      a housing including:
         an aperture configured to permit light radiation to pass therethrough,
         a locking feature configured to mate with a complementary locking feature of the bio-imaging device, and
         at least one positioning feature configured to mate with a complementary positioning feature of the bio-imaging device;
      an illumination source disposed within the housing and configured to generate light radiation;
      a dichroic splitter disposed in optical communication with the aperture and the illumination source;
      a reflector disposed in optical communication with the dichroic splitter and the optical sensor;
      an optical sensor disposed in optical communication with the reflector; and
      optionally a lens disposed in optical communication with the reflector and the optical sensor; and
   the second optical module comprises:
      a second housing including:
         a second aperture configured to permit light radiation to pass therethrough,
         a second locking feature configured to mate with a second complementary locking feature of the bio-imaging device, and
         at least one second positioning feature configured to mate with a complementary second positioning feature of the bio-imaging device;
      a second illumination source disposed within the second housing and configured to generate light radiation;
      a second dichroic splitter disposed in optical communication with the second aperture and the second illumination source;
      a second reflector disposed in optical communication with the second dichroic splitter and the second optical sensor;
      a second optical sensor disposed in optical communication with the second reflector; and
      optionally a second lens disposed in optical communication with the second reflector and the second optical sensor.
Example 3. The bio-imaging device of Example 1 or Example 2 further comprising:
   a third optical module receiver; and
   a third optical module configured to reversibly mate with the third optical receiver.
Example 4. The bio-imaging device of Example 3, wherein the third optical module comprises:
   a third housing including:
      a third aperture configured to permit light radiation to pass therethrough,
      a third locking feature configured to mate with a third complementary locking feature of the bio-imaging device, and
      at least one third positioning feature configured to mate with a complementary third positioning feature of the bio-imaging device;
   a third illumination source disposed within the third housing and configured to generate light radiation;
   a third dichroic splitter disposed in optical communication with the third aperture and the third illumination source;
   a third reflector disposed in optical communication with the third dichroic splitter and the third optical sensor;
   a third optical sensor disposed in optical communication with the third reflector; and
   optionally a third lens disposed in optical communication with the second reflector and the second optical sensor.
Example 5. The bio-imaging device of any one preceding Example, wherein the mirror includes at least two reflective faces.
Example 6. The bio-imaging device of Example 5, wherein a first face of the mirror is configured to place a first scan lens in optical communication with the first optical module.
Example 7. The bio-imaging device of Example 6, wherein a second face of the mirror is configured to place a second scan lens in optical communication with the second optical module.
Example 8. The bio-imaging device of Example 6 or Example 7, wherein the first face of the mirror or the second face of the mirror is configured to place a third scan lens in optical communication with the third optical module.
Example 9. The bio-imaging device of any preceding Example, wherein the scan head is configured to move relative to the scan bed.
Example 10. The bio-imaging device of any one of Examples 3-9, wherein the scan head is in optical communication with the third optical module and further comprises a third scan lens in optical communication with the third optical module.
Example 11. The bio-imaging device of Example 10, wherein the scan head does not include a dye limiting filter disposed between the third scan lens and the mirror.
Example 12. The bio-imaging device of any one preceding Example, wherein the first dye limiting filter is a dual bandpass filter.
Example 13. The bio-imaging device of Example 12, wherein the dual bandpass filter has a first working wavelength range of 320-525 nm and a second working wavelength range of 620-750 nm.
Example 14. The bio-imaging device of any one preceding Example, wherein the second dye limiting filter is a dual bandpass filter.
Example 15. The bio-imaging device of Example 14, wherein the second dual bandpass filter has a working wavelength range that does not overlap with a working wavelength range of the first dye limiting filter.
Example 16. The bio-imaging device of Example 14 or Example 15, wherein the second dual bandpass filter has a first working wavelength range of 530-620 nm and a second working wavelength range of 760-900 nm.
Example 17. An optical module comprising:
   a housing including:
      an aperture configured to permit light radiation to pass therethrough,
      a locking feature configured to mate with a complementary locking feature of a bio-imaging device, and
      at least one positioning feature configured to mate with a complementary positioning feature of a bio-imaging device;
   an illumination source disposed within the housing and configured to generate light radiation;
   a dichroic splitter disposed in optical communication with the aperture and the illumination source;
   a reflector disposed in optical communication with the dichroic splitter and the optical sensor;
   an optical sensor disposed in optical communication with the reflector; and
   optionally a lens disposed in optical communication with the reflector and the optical sensor.
Example 18. The optical module of Example 17 further comprising an excitation filter in optical communication with the illumination source and the dichroic splitter.
Example 19. The optical module of Example 17 or Example 18 further comprising a filter disposed in optical communication with the lens and the optical sensor.
Example 20. The optical module of any one of Examples 17-19 further comprising a second aperture disposed between the lens and the optical sensor.
Example 21. The optical module of any one of Examples 17-20, wherein the optical sensor is disposed within the housing.
Example 22. The optical module of any one of Examples 17-20, wherein the optical sensor is disposed on an exterior surface of the housing.
Example 23 The optical module of any one of Examples 17-22, wherein the illumination source emits light radiation having a wavelength of about 488 nm, about 532 nm, about 638 nm, about 658 nm, about 685 nm, or about 780 nm.
Example 24. The optical module of any one of Examples 17-23, wherein the optical module is configured to illuminate a specimen and/or receive light from a specimen for phosphor imaging, FRET imaging, NIR imaging, red fluorescent imaging, green fluorescent imaging, or blue fluorescent imaging.
Example 25. The optical module of any one of Examples 17-24, wherein the at least one positioning feature is disposed to prevent the optical module from being inserted into one or more receiver of a multi-receiver bio-imaging device.
Example 26. The optical module of any one of Examples 17-25, wherein the locking feature is configured to mate with the complementary positioning feature of a bio-imaging device to align the optical sensor with a scan head of the bio-imaging device at a tolerance of not more than 0.1 mm.
Example 27. A bio-imaging device comprising:
   a scan bed including a surface configured to support a biological specimen;
   a scan head disposed below the scan bed and including at least one mirror disposed at an acute angle relative to the surface of the scan bed;
   a first receiver configured to:
      secure a first optical module of any one of Examples 17-26, and
      optically align the first optical module with a mirror of the scan head;
   a second receiver configured to:
      secure a second, different optical module of any one of Examples 17-26, and
      optically align the second, different optical module with a mirror of the scan head.
Example 28. The bio-imaging device of Example 27, wherein the first receiver is configured to secure the first optical module temporarily.
Example 29. The bio-imaging device of Example 27 or Example 28, wherein the second receiver is configured to secure the second, different optical module temporarily.
Example 30. The bio-imaging device of any one of Examples 27-29 further comprising a third receiver configured to:
   secure a third, different optical module of any one of Examples 17-26; and
   optically align the third, different optical module with a mirror of the scan head.
Example 31. The bio-imaging device of any one of Examples 27-30, wherein the at least one mirror of the scan head consists essentially of a single mirror having at least:
   a first mirror portion disposed at a first acute angle relative to the surface of the scan bed; and
   a second mirror portion disposed at a second, different acute angle relative to the surface of the scan bed.
Example 32. The bio-imaging device of Example 31, wherein the single mirror has a substantially V-shaped cross-sectional shape.
Example 33. A kit comprising:
   a first optical module of any one of Examples 17-26;
   a second, different optical module of any one of Examples 17-26;
   a third, different optical module of any one of Examples 17-26; and
   a bio-imaging device of any one of Examples 27-32.
Example 34. The kit of Example 33 further comprising a fourth optical module of any one of Examples 17-26.
Example 35. The kit of Example 31 further comprising a fifth optical module of any one of Examples 17-26.
Example 36. A method of obtaining a bio-image of a specimen, the method comprising:
   mating a first optical module of any one of Examples 17-26 with a first receiver of a bio-imaging device of any one of Examples 27-32;
   optionally mating a second optical module of any one of Examples 17-26 with a second receiver of a bio-imaging device of any one of Examples 27-32;
   optionally mating a third optical module of any one of Examples 17-26 with a third receiver of a bio-imaging device of any one of Examples 27-32;
   placing a biological specimen on the scan bed of the bio-imaging device; and
   obtaining a single-channel or a multi-channel bio-image of the biological specimen via the first optical module, the optional second optical module, and/or the optional third optical module.
Example 37. The method of Example 36, wherein the step of obtaining the bio-image comprises:
   energizing the illumination source of the first optical module;
   observing, via the optical sensor of the first optical module, an emission or reflectance signal of the biological substrate based on excitation of the biological specimen by the illumination source;
   optionally energizing the second illumination source of the second optical module;
   optionally observing, via the second optical sensor, an emission or reflectance signal of the biological substrate based on excitation of the biological specimen by the second illumination source;
   optionally energizing the third illumination source; and
   optionally observing, via the third optical sensor, an emission or reflectance signal of the biological substrate based on excitation of the biological specimen by the third illumination source.
Example 38. The method of Example 37, wherein the method further comprises:
   removing a fourth optical module from the first receiver of the bio-imaging device; and
   thereafter mating the first optical module with the first receiver before the step of energizing the illumination source of the first module.
Example 39. A bio-imaging device comprising:
   a first optical module receiver configured to mate with a first removable optical module configured to emit and/or detect light for FRET, NIR, red, blue, or green fluorescent imaging;
   a second optical module receiver configured to mate with a second removable optical module configured to emit and/or detect light for blue or red fluorescent imaging;
   a third optical module receiver configured to mate with a third removable optical module configured to emit and/or detect light for NIR or green fluorescent imaging;
   a scan bed configured to support a biological sample; and
   a scan head disposed to enable relay of light radiation from the first, second, and third removable optical modules with a biological sample supported by the scan bed, wherein the scan head comprises:
      a first dye limiting filter disposed between a first lens and a mirror and having at least two working wavelength ranges, and
      a second dye limiting filter disposed between a second lens and a mirror and having at least two working wavelength ranges that do not overlap with the working wavelength ranges of the first dye limiting filter.
Example 40. The bio-imaging device of Example 39, wherein the scan head comprises:
   a first reflective surface configured to redirect light emitted by the first removable optical module to the biological sample; and
   a second reflective surface configured to redirect light emitted by the second removable optical module and the third removable optical module to the biological sample.
Example 41. The bio-imaging device of Example 39 or Example 40, wherein the scan head comprises:
   a first lens disposed between the first reflective surface and the scan bed and configured to focus light emitted by the first removable optical module to the scan bed;
   a second lens disposed between the second reflective surface and the scan bed and configured to focus light emitted by the second removable optical module to the scan bed; and
   a third lens disposed between the second reflective surface and the scan bed and configured to focus light emitted by the third removable optical module to the scan bed.
Example 42. The bio-imaging device of Example 41 further comprising:
   an optional first filter disposed between the first reflective surface and the first lens and configured to enable passage of light for FRET, NIR, red, green, and blue fluorescent imaging;
   a second filter disposed between the second reflective surface and the second lens and configured to enable passage of light for blue and red fluorescent imaging; and
   a third filter disposed between the second reflective surface and the third lens and configured to enable passage of light for NIR and green fluorescent imaging.
Example 43. The bio-imaging device of Example 42, wherein a working wavelength range of the second filter does not overlap with a working wavelength range of the third filter.
Example 44. The bio-imaging device of Example 42 or Example 43, wherein the second filter is a 320-525 nm/620-750 nm dual bandpass filter.
Example 45. The bio-imaging device of any one of Examples 42-44, wherein the third filter is a 530-620 nm/760-900 nm dual bandpass filter.
Example 46. The bio-imaging device of any one of Examples 39-45, wherein the second optical module receiver is configured to not mate with an optical module configured to emit fluorescent, NIR, or green light.
Example 47. The bio-imaging device of any one of Examples 39-46, wherein the third optical module receiver is configured not to mate with an optical module configured to emit FRET, red, or blue light.

What is claimed is:

1. A bio-imaging device comprising:
a first optical module;
a second optical module;
a scan bed configured to support a biological substrate and enable light radiation to pass therethrough; and
a scan head disposed below the scan bed and in optical communication with the first optical module and the second optical module, the scan head comprising:
a first scan lens in optical communication with the first optical module,
a second scan lens in optical communication with the second optical module,
a mirror in optical communication with each of the plurality of scan lenses, a first dye limiting filter disposed between the first scan lens and the mirror, and
a second dye limiting filter disposed between the second scan lens and the mirror.

2. The bio-imaging device of claim 1, wherein:
the first optical module comprises:
a housing including:
an aperture configured to permit light radiation to pass therethrough,
a locking feature configured to mate with a complementary locking feature of the bio-imaging device, and
at least one positioning feature configured to mate with a complementary positioning feature of the bio-imaging device;
an illumination source disposed within the housing and configured to generate light radiation;
a dichroic splitter disposed in optical communication with the aperture and the illumination source;
a reflector disposed in optical communication with the dichroic splitter and the optical sensor;
an optical sensor disposed in optical communication with the reflector; and
optionally a lens disposed in optical communication with the reflector and the optical sensor; and
the second optical module comprises:
a second housing including:
a second aperture configured to permit light radiation to pass therethrough,
a second locking feature configured to mate with a second complementary locking feature of the bio-imaging device, and
at least one second positioning feature configured to mate with a complementary second positioning feature of the bio-imaging device;
a second illumination source disposed within the second housing and configured to generate light radiation;
a second dichroic splitter disposed in optical communication with the second aperture and the second illumination source;
a second reflector disposed in optical communication with the second dichroic splitter and the second optical sensor;
a second optical sensor disposed in optical communication with the second reflector; and
optionally a second lens disposed in optical communication with the second reflector and the second optical sensor.

3. The bio-imaging device of claim 1 further comprising:
a third optical module receiver; and
a third optical module configured to reversibly mate with the third optical receiver.

4. The bio-imaging device of claim 3, wherein the third optical module comprises:
a third housing including:
a third aperture configured to permit light radiation to pass therethrough,
a third locking feature configured to mate with a third complementary locking feature of the bio-imaging device, and
at least one third positioning feature configured to mate with a complementary third positioning feature of the bio-imaging device;
a third illumination source disposed within the third housing and configured to generate light radiation;
a third dichroic splitter disposed in optical communication with the third aperture and the third illumination source;
a third reflector disposed in optical communication with the third dichroic splitter and the third optical sensor;
a third optical sensor disposed in optical communication with the third reflector; and
optionally a third lens disposed in optical communication with the second reflector and the second optical sensor.

5. The bio-imaging device of claim 1, wherein the mirror includes at least two reflective faces.

6. The bio-imaging device of claim 5, wherein a first face of the mirror is configured to place a first scan lens in optical communication with the first optical module.

7. The bio-imaging device of claim 6, wherein a second face of the mirror is configured to place a second scan lens in optical communication with the second optical module.

8. The bio-imaging device of claim 6, wherein the first face of the mirror or the second face of the mirror is configured to place a third scan lens in optical communication with the third optical module.

9. The bio-imaging device of claim 1, wherein the scan head is configured to move relative to the scan bed.

10. The bio-imaging device of claim 3, wherein the scan head is in optical communication with the third optical module and further comprises a third scan lens in optical communication with the third optical module.

11. The bio-imaging device of claim 10, wherein the scan head does not include a dye limiting filter disposed between the third scan lens and the mirror.

12. The bio-imaging device of claim 1, wherein the first dye limiting filter is a dual bandpass filter.

13. The bio-imaging device of claim 12, wherein the dual bandpass filter has a first working wavelength range of 320-525 nm and a second working wavelength range of 620-750 nm.

14. The bio-imaging device of claim 1, wherein the second dye limiting filter is a dual bandpass filter.

15. The bio-imaging device of claim 14, wherein the second dual bandpass filter has a working wavelength range that does not overlap with a working wavelength range of the first dye limiting filter.

16. The bio-imaging device of claim 14, wherein the second dual bandpass filter has a first working wavelength range of 530-620 nm and a second working wavelength range of 760-900 nm.

17. A bio-imaging device comprising:
a first optical module receiver configured to mate with a first removable optical module configured to emit and/or detect light for FRET, NIR, red, blue, or green fluorescent imaging;
a second optical module receiver configured to mate with a second removable optical module configured to emit and/or detect light for blue or red fluorescent imaging;
a third optical module receiver configured to mate with a third removable optical module configured to emit and/or detect light for NIR or green fluorescent imaging;
a scan bed configured to support a biological sample; and
a scan head disposed to enable relay of light radiation from the first, second, and third removable optical modules with a biological sample supported by the scan bed, wherein the scan head comprises:
a first dye limiting filter disposed between a first lens and a mirror and having at least two working wavelength ranges, and
a second dye limiting filter disposed between a second lens and a mirror and having at least two working wavelength ranges that do not overlap with the working wavelength ranges of the first dye limiting filter.

18. The bio-imaging device of claim 17, wherein the scan head comprises:
a first reflective surface configured to redirect light emitted by the first removable optical module to the biological sample; and
a second reflective surface configured to redirect light emitted by the second removable optical module and the third removable optical module to the biological sample.

19. The bio-imaging device of claim 17, wherein the scan head comprises:
a first lens disposed between the first reflective surface and the scan bed and configured to focus light emitted by the first removable optical module to the scan bed;
a second lens disposed between the second reflective surface and the scan bed and configured to focus light emitted by the second removable optical module to the scan bed; and
a third lens disposed between the second reflective surface and the scan bed and configured to focus light emitted by the third removable optical module to the scan bed.

20. The bio-imaging device of claim 19 further comprising:
an optional first filter disposed between the first reflective surface and the first lens and configured to enable passage of light for FRET, NIR, red, green, and blue fluorescent imaging;
a second filter disposed between the second reflective surface and the second lens and configured to enable passage of light for blue and red fluorescent imaging; and
a third filter disposed between the second reflective surface and the third lens and configured to enable passage of light for NIR and green fluorescent imaging.
